(19) United States
(12) Patent Application Publication
(10) Pub. No.: US 2017/0347219 A1
(43) Pub. Date: Nov. 30, 2017

(54) SELECTIVE AUDIO REPRODUCTION

(71) Applicant: VideoStitch Inc., San Francisco, CA (US)

(72) Inventors: Lucas McCauley, Vincennes (FR); Stéphane Valente, Paris (FR); Alexander Fink, San Jose, CA (US); Nicolas Burtey, Mountain View, CA (US)

(21) Appl. No.: 15/166,865

(22) Filed: May 27, 2016

(51) Int. Cl. H04S 7/00; H04N 13/04; H04S 3/00; G06F 3/0488; G06F 3/0481

(52) U.S. Cl. CPC H04S 7/304; H04S 7/303; H04N 13/0445; H04N 13/0497; H04S 3/008; G06F 3/04815; G06F 3/0488; H04S 2400/01; H04S 2400/11; H04S 2400/13; H04S 2420/11

(57) ABSTRACT

A system comprising a video display device, an audio output device and a computing device. The computing device may comprise one or more processors configured to (i) determine orientation angles of a spherical video based on an input, (ii) extract a viewport from the spherical video based on the orientation angles, (iii) output the viewport to the video display device, (iv) render a sound field based on the orientation angles and the audio output device and (v) output the sound field to the audio output device. Sound sources that comprise the sound field are adjusted to align with the viewport. The sound sources outside of the viewport are attenuated.

### FIELD OF THE INVENTION

The invention relates to audio and video generally and, more particularly, to a method and/or apparatus for implementing a selective audio reproduction.

### BACKGROUND

A 360 degree video can be represented in various formats (i.e., 2D equirectangular, cubic projections, etc.). When the 360 degree video is rendered for a user, a spherical representation is projected back to a rectilinear format. The rectilinear format can be rendered using a head-mounted display (HMD) where a position and orientation of the head of a viewer can be tracked. The projection of the spherical scene can be adjusted to match the moving point of view of the viewer. The rectilinear format can also be rendered on a portable display (i.e., a smartphone, a tablet computing device, etc.). On a portable device, the point of view rendered on the display is adjusted to follow the position and orientation of the portable display. Another possibility is to render the spherical video on a stationary display (i.e., TV, a smart TV, a computer monitor, etc.) that does not move like a HMD or a portable display. For a stationary display, the point of view rendered from the spherical representation is adjusted using a separate input device (i.e., a computer mouse, remote control, a gamepad, etc.).

For the audio, a 3D sound field can be represented in B-format audio (e.g., ambisonics) or in an object-audio format (e.g., Dolby Atmos) by “panning” a mono audio source in 3D space using two angles (traditionally called θ and φ). Ambisonics uses at least four audio channels (B-format audio) to encode the whole 360 degree sound sphere. Object-audio uses mono or stereo audio “objects” having associated metadata to indicate a position to a proprietary renderer (i.e., usually referred to as VBAP (vector base amplitude panning)). To play back ambisonic audio, a decoder is used to derive desired output channels. Similar to video, the sound field can be rendered through motion-tracked headphones using binaural technologies that adjust the “point of hearing” (similar to the point of view in a spherical video) to match the head position and orientation of the viewer. The spherical sound field can also be rendered through the speaker(s) of a portable device, with the content rendered to match the video point of view. Another possibility is to render the sound field through the speaker(s) of a stationary device.

Rendering an immersive sound field with HMDs allows the sound field orientation to match the video point of view based on the orientation of the head of the viewer. Using binaural processing of immersive audio, the viewer experiences full immersion, both visual and auditory.

When using non-binaural rendering (excluding multi-speaker surround and/or immersive speaker setups), playing back the full sound field (including sounds located behind the point of view of the viewer) can be distracting for a viewer. The distraction can even ruin the intelligibility on mono or stereo speakers (commonly found in consumer devices) since the viewer is hearing things that are not seen and do not relate to the image displayed. The distraction is not a problem when using binaural processing since sounds appear to originate from the intended position of the sound (above, behind, left, etc.). With binaural processing, the frontal sound stage is not cluttered.

It would be desirable to implement a selective audio reproduction. When a 360 degree video is associated with immersive audio, it would therefore be desirable to only hear (or mostly hear) sounds that come from objects that are visible in the viewport, especially when played back on smartphone, tablet or TV speakers.

### SUMMARY

The invention concerns a system comprising a video display device, an audio output device and a computing device. The computing device may comprise one or more processors configured to (i) determine orientation angles of a spherical video based on an input, (ii) extract a viewport from the spherical video based on the orientation angles, (iii) output the viewport to the video display device, (iv) render a sound field based on the orientation angles and the audio output device and (v) output the sound field to the audio output device. Sound sources that comprise the sound field are adjusted to align with the viewport. The sound sources outside of the viewport are attenuated.

### BRIEF DESCRIPTION OF THE FIGURES

Embodiments of the invention will be apparent from the following detailed description and the appended claims and drawings in which:

FIG. 1 is a diagram illustrating a system according to an example embodiment of the present invention;

FIG. 2 is a diagram illustrating an equirectangular projection of a spherical video;

FIG. 3 is a diagram illustrating a viewport of a spherical video displayed on a stationary video display device;

FIG. 4 is a diagram illustrating a viewport of a spherical video displayed on a portable video display device;

FIG. 5 is a diagram illustrating a spherical audio and video;

FIG. 6 is a diagram illustrating a polar representation of audio sources;

FIG. 7 is a flow diagram illustrating a method for adjusting an attenuation of audio sources;

FIG. 8 is a flow diagram illustrating a method for rendering selective audio playback;

FIG. 9 is a flow diagram illustrating a method for enabling selective audio playback based on an output audio device; and

FIG. 10 is a flow diagram illustrating a method for selective audio rendering of ambisonic and/or object-based audio sources.

### DETAILED DESCRIPTION OF THE EMBODIMENTS

Embodiments of the present invention include providing a selective audio reproduction that may (i) align sounds with the current viewport, (ii) compensate for level differences, (iii) selectively render ambisonic audio sources, (iv) selectively render audio objects, (v) be disabled when at least one of binaural processing, multi-speaker surround audio and/or immersive speaker setups are available, (vi) attenuate non-visible sound sources when some off-screen sound is desired, (vii) decode to a representation of virtual speakers, (viii) rotate a sound field and/or (ix) be easy to implement.

Embodiments of the invention may implement selective audio reproduction in order to render an immersive video and/or immersive sound field adapted for a 2D display and forward audio output. The immersive video may be a video stream. The immersive sound field may be an immersive sound field stream. In an example, the immersive sound field may be implemented as object-based and/or ambisonic audio. A direction of the immersive sound field may be attenuated dynamically to match a video viewport. Playback of the dynamically attenuated immersive sound file may automatically switch between binaural and transaural sound based on the type (e.g., playback capability) of the audio output device. In an example, when headphones that provide binaural processing are used as the audio output device, the dynamic directional attenuation of the immersive sound field may be disabled.

Generally, only a portion of a full 360 degree spherical video is shown to a viewer at any one time. Embodiments of the invention may be configured to implement selective audio reproduction by only playing back sound from the portion of the audio scene that is visible in the viewport and/or give much greater importance (e.g., level) to the visible part of the audio sphere. For example, the selective audio reproduction may be implemented if a 360 degree soundtrack (e.g., ambisonics and/or VBAP) is available.

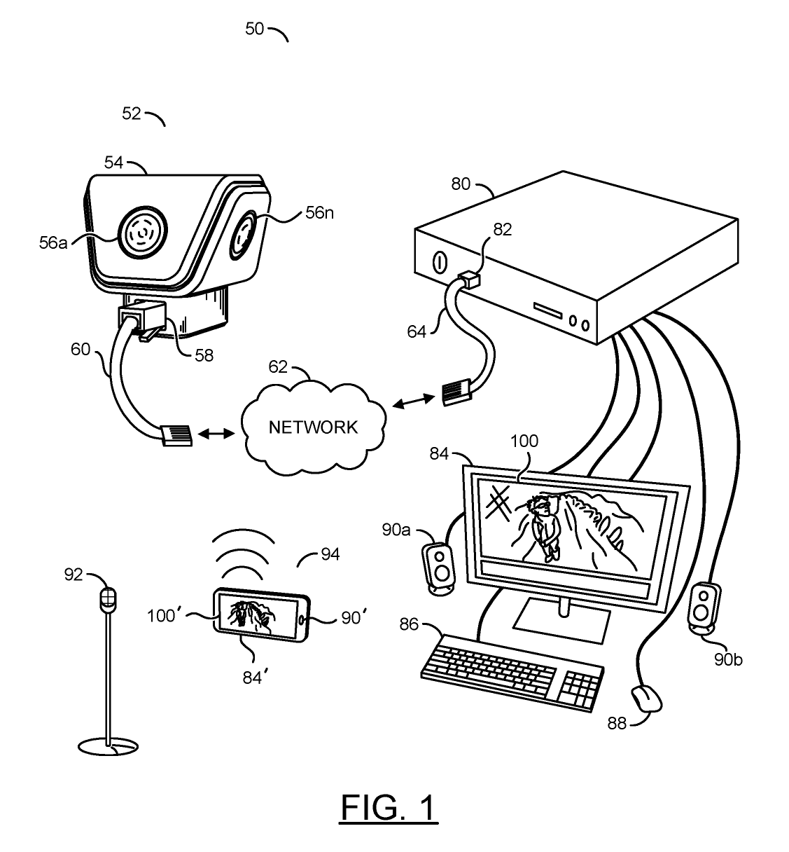

Referring to FIG. 1, a diagram illustrating a system 50 according to an example embodiment of the present invention is shown. The system 50 may comprise a capture device 52, a network 62, a computing device 80, a video display device 84, audio output devices 90a-90b, an audio capture device 92 and/or a playback interface 100. The system 50 may be configured to capture video of an environment surrounding the capture device 52, capture audio of an environment surrounding the audio capture device 92, transmit the video and/or audio to the computing device 80 via the network 62, playback the video on the video display device 84, playback the audio via the audio output devices 90a-90b and allow a user to interact with the video and/or audio with the playback interface 100. Other components may be implemented as part of the system 50.

The capture device 52 may comprise a structure 54, lenses 56a-56n, and/or a port 58. Other components may be implemented. The structure 54 may provide support and/or a frame for the various components of the capture device 52. The lenses 56a-56n may be arranged in various directions to capture the environment surrounding the capture device 52. In an example, the lenses 56a-56n may be located on each side of the capture device 52 to capture video from all sides of the capture device 52 (e.g., provide a video source, such as a spherical field of view). The port 58 may be configured to enable data to be communicated and/or power to be transmitted and/or received. The port 58 is shown connected to a wire 60 to enable communication with the network 62. In some embodiments, the capture device 52 may also comprise an audio capture device (e.g., a microphone) for capturing audio sources surrounding the capture device 52.

The computing device 80 may comprise memory and/or processing components for performing video and/or audio encoding operations. The computing device 80 may be configured to perform video stitching operations. The computing device 80 may be configured to read instructions and/or execute commands. The computing device 80 may comprise one or more processors. The processors of the computing device 80 may be configured to analyze video data and/or perform computer vision techniques. In an example, the processors of the computing device 80 may be configured to automatically determine a location of particular objects in a video frame. The computing device 80 may be configured to perform operations to encode and/or decode an immersive video (e.g., spherical video frames) and/or an immersive sound field. In an example, the computing device 80 may provide output to the video display device 84 and/or the audio output devices 90a-90b to playback the immersive video and/or immersive sound field.

The computing device 80 may comprise a port 82. The port 82 may be configured to enable communications and/or power to be transmitted and/or received. The port 82 is shown connected to a wire 64 to enable communication with the network 62. The computing device 80 may comprise various input/output components to provide a human interface. The video output device 84, a keyboard 86, a pointing device 88 and the audio output devices 90a-90b are shown connected to the computing device 80. The keyboard 86 and/or the pointing device 88 may enable human input to the computing device 80. The video output device 84 is shown displaying the playback interface 100. In an example, the video output device 84 may be implemented as a computer monitor. In some embodiments, the computer monitor 84 may be configured to enable human input (e.g., the video output device 84 may be a touchscreen device). In an example, the audio output devices 90a-90b may be implemented as computer speakers. In some embodiments, the computer speakers 90a-90b may be stereo speakers generally located in front of a user (e.g., next to the computer monitor 84).

The computing device 80 is shown as a desktop computer. In some embodiments, the computing device 80 may be a mini computer. In some embodiments, the computing device 80 may be a micro computer. In some embodiments, the computing device 80 may be a notebook (laptop) computer. In some embodiments, the computing device 80 may be a tablet computing device. In some embodiments, the computing device 80 may be a smart TV. In some embodiments, the computing device 80 may be a smartphone. The format of the computing device 80 and/or any peripherals (e.g., the display 84, the keyboard 86 and/or the pointing device 88) may be varied according to the design criteria of a particular implementation.

An example smartphone embodiment 94 is shown. In some embodiments, the smartphone 94 may implement the processing (e.g., video stitching, video encoding/decoding, audio encoding/decoding, etc.) functionality of the computing device 80. In some embodiments, the smartphone 94 may be configured to playback the spherical video and/or immersive sound field received from the computing device 80. The smartphone 94 is shown comprising a touchscreen display 84′. In an example, the touchscreen display 84′ may be the video output device for the smartphone 94 and/or human interface for the smartphone 94. The smartphone 94 is shown comprising the speaker 90′. The speaker 90′ may be the audio output device for the smartphone 94. The smartphone 94 is shown displaying the playback interface 100′.

In some embodiments, the smartphone 94 may provide an application programming interface (API). The playback interface 100′ may be configured to use the API of the smartphone 94 and/or system calls to know if a headphone jack is plugged in. The API may be implemented to determine a playback capability of the audio output device 90′. In an example, when the headphone jack is determined to be plugged in, binaural rendering may be used to decode the full audio sphere. With binaural rendering the sounds may appear to originate at an intended position for each of the audio sources (e.g., above, behind, left, etc.). In an example, if the operating system level API of the smartphone 94 indicates the headphones are not available, the selective decoding technique can be used. Similar functionality may be implemented for Bluetooth-connected devices. For example, binaural processing may be implemented for Bluetooth headphones and selective audio decoding for speakers (e.g., speakers that do not provide multi-speaker surround sound or immersive speaker setups). The selective audio reproduction may be disabled when the audio playback device 90a-90b supports immersive audio rendering (e.g., binaural processing, multi-speaker surround audio and/or immersive speaker setups).

The audio capture device 92 may be configured to capture audio (e.g., sound) sources from the environment. Generally, the audio capture device 92 is located near the capture device 52. In some embodiments, the audio capture device may be a built-in component of the capture device 52. The audio capture device 92 is shown as a microphone. In some embodiments, the audio capture device 92 may be implemented as a lapel microphone. For example, the audio capture device 92 may be configured to move around the environment (e.g., follow the audio source). In some embodiments, the audio capture device 92 may be a sound field microphone configured to capture one or more audio sources from the environment. Generally, one or more of the audio capture device 92 may be implemented to capture audio sources from the environment. The implementation of the audio device 92 may be varied according to the design criteria of a particular implementation.

The playback interface 100 may enable a user to playback audio sources in a “3D” or “immersive” audio sound field relative to the 360 degree video. The playback interface 100 may be a graphical user interface (GUI). The playback interface 100 may allow the user to play, pause, edit and/or modify the spherical view and/or audio associated with the spherical view. The playback interface 100 may be technology-agnostic. For example, the playback interface 100 may work with various audio formats (e.g., B-format equations for ambisonic-based audio, metadata for object audio-based systems, etc.) and/or video formats. A general functionality of the playback interface 100′ for the smartphone 94 may be similar to the playback interface 100 (e.g., the GUI may be different for the playback interface 100′ to accommodate touch-based controls).

The playback interface 100 may be implemented as computer executable instructions. In an example, the playback interface 100 may be implemented as instructions loaded in the memory of the computing device 80. In another example, the playback interface 100 may be implemented as an executable application configured to run on the smartphone 94 (e.g., an Android app, an iPhone app, a Windows Phone app, etc.). In another example, the playback interface 100 may be implemented as an executable application configured to run on a smart TV (e.g., the video output device 84 configured to run an operating system such as Android). The implementation of the playback interface 100 may be varied according to the design criteria of a particular implementation.

The playback interface 100 may be implemented to enable monitoring (e.g., providing a preview) of live streaming of a spherical video stream (e.g., from the capture device 52). In an example, the playback interface 100 may provide a preview window to allow a user see what the final stitched video will look like after being rendered. In some embodiments, the playback interface 100 preview may display the spherical video through a viewport (e.g., not as a full equirectangular projection). For example, the viewport may provide a preview of what a viewer would see when viewing the video (e.g., on a head-mounted display, on YouTube, on other 360 degree players, etc.). In this context, the selective audio decoding may be implemented to allow a content creator to verify that the sound is adjusted as desired and augments the experience by providing more immersive/dynamic audio.

In some embodiments, the playback interface 100 may provide a preview window in a live video streaming application. For example, the playback interface 100 may be configured to preview video and/or audio in a real-time capture from the capture device 52 and/or pre-recorded files. The playback interface 100 may be used to aid in alignment of a 3D audio microphone such as the audio capture device 92. For example, a content creator may adjust the video by ear (e.g., turn the microphone 92 to hear what the viewer sees). Implementing the selective audio reproduction may further improve a quality of the viewing experience by providing a less cluttered soundscape, since audio sources that are not visible in the preview playback interface 100 may not be heard when viewed (or will be reproduced to be less audible). Similarly, the capture device 52 may provide a preview application for computing devices (e.g., the computing device 80 and/or the smartphone 94) to monitor output.

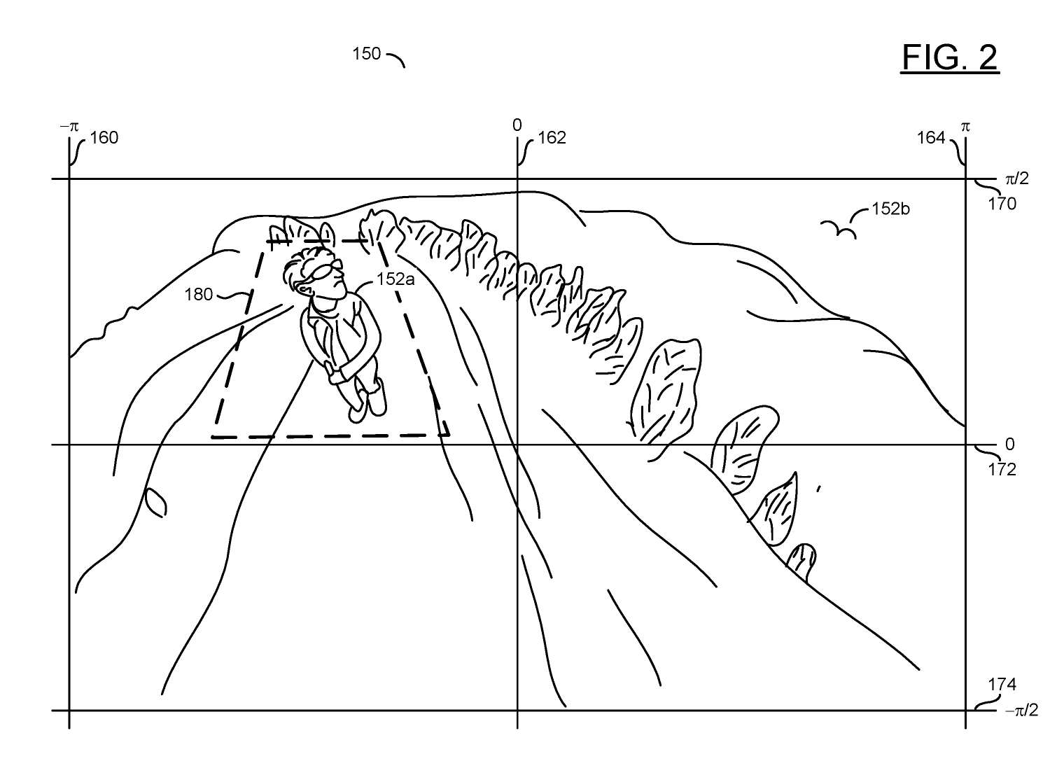

Referring to FIG. 2, a diagram illustrating an equirectangular projection 150 of the spherical video is shown. The equirectangular projection 150 may be a 2D projection of the entire spherical field of view. In some embodiments, the equirectangular projection 150 may be displayed on the video output device 84. In an example, viewing the equirectangular projection 150 may be useful to a content creator. The equirectangular projection 150 may provide a distorted version of the captured environment (e.g., the distortion may be due to projecting the spherical video onto a 2D representation). Orientation angles may be determined from the equirectangular projection 150 to provide the viewport to the video output display 84.

Audio sources 152a-152b are shown on the equirectangular projection 150. In an example, the audio source 152a may be a person speaking. In another example, the audio source 152b may be a bird call. The audio sources 152a-152b may be captured by the audio capture device 92 (e.g., the audio sources 152a-152b may generate audio signals captured by the audio capture device 92). In some embodiments, locations of the audio sources 152a-152b may be determined by data provided by the audio capture device 92. In one example, the location of the audio sources 152a-152b may be provided using an ambisonic format (e.g., based on B-format equations). In another example, the location of the audio sources 152a-152b may be provided using an object-audio format (e.g., based on metadata coordinates). The number and/or types of audio sources in the spherical video may be varied according to the design criteria of a particular implementation.

A vertical axis 160, a vertical axis 162 and a vertical axis 164 are shown overlaid on the equirectangular projection 150. The vertical axis 160 may correspond to a longitude angle −π. The vertical axis 162 may correspond to a longitude angle 0. The vertical axis 164 may correspond to a longitude angle π. The orientation angles may have a longitude angle value between −π and π.

A horizontal axis 170, a horizontal axis 172 and a horizontal axis 174 are shown overlaid on the equirectangular projection 150. The horizontal axis 170 may correspond to a latitude angle π/2. The horizontal axis 172 may correspond to a latitude angle 0. The horizontal axis 174 may correspond to a latitude angle −π/2. The orientation angles may have a longitude angle value between −π/2 and π/2.

A viewport 180 is shown. The viewport 180 may be dependent upon where a viewer of the spherical video is currently looking. In an example of a head-mounted display, the viewport 180 may be determined based on a head location and/or rotation of the viewer. In an example of a portable device (e.g., the smartphone 94) the viewport 180 may be determined based on sensor information (e.g., magnetometer, gyroscope, accelerometer, etc.). In an example of a stationary device, the viewport 180 may be determined based on user input (e.g., the mouse 88, keystrokes from the keyboard 86, input from a gamepad, etc.). In some embodiments, the viewport 180 may be determined by other control data. In an example, the control data used to select the viewport 180 may implement a pre-determined point of view selected by a director, content creator and/or broadcast network (e.g., the viewport 180 may be selected to present an “on rails” spherical video sequence). In the example shown, the viewport 180 is directed at the person speaking (e.g., the audio source 152a). Generally, the orientation angle for the viewport 180 is between around 0 and π/2 in latitude and between −π and 0 in longitude. The location of the viewport 180 may change as the input is changed.

The rendering application implemented by the computing device 80 may determine a 3D orientation (e.g., the orientation angles) in terms of the longitude θ and latitude φ angles. For example, the orientation angles may be determined based on an input from the viewer. Based on the orientation angles, the viewport 180 may be extracted from the equirectangular projection 150. The viewport 180 may be reprojected into a rectilinear view adapted to the video output device 84 (e.g., the viewport 180 may be rendered on the video output device 84).

The computing device 80 may be configured to render the immersive sound field. For example, the computing device may render the immersive sound field and the viewport 180 in parallel. The immersive sound field may be rendered based on the orientation angles (e.g., the orientation angles used to determine the viewport 180). Rendering the immersive sound field using the orientation angles used to determine the viewport 180 may steer the various sound sources (e.g., the audio sources 152a-152b) so that an alignment of the sound sources matches the video viewport 180.

In some embodiments, the selective audio reproduction performed by the computing device 80 and/or the playback interface 100 may render the immersive audio such that sounds (e.g., the audio sources 152a-152b) that have the same position as the video displayed in the viewport 180 are played. In some embodiments, the selective audio reproduction performed by the computing device 80 and/or the playback interface 100 may render the immersive audio such that sounds (e.g., the audio sources 152a-152b) that are outside of position of the video displayed in the viewport 180 are attenuated when played (e.g., silenced or played back at a reduced level). The computing device 80 may adjust the selective audio reproduction to have equal power to the full sound field recording to compensate for level differences created due to only decoding a part of the full immersive sound field.

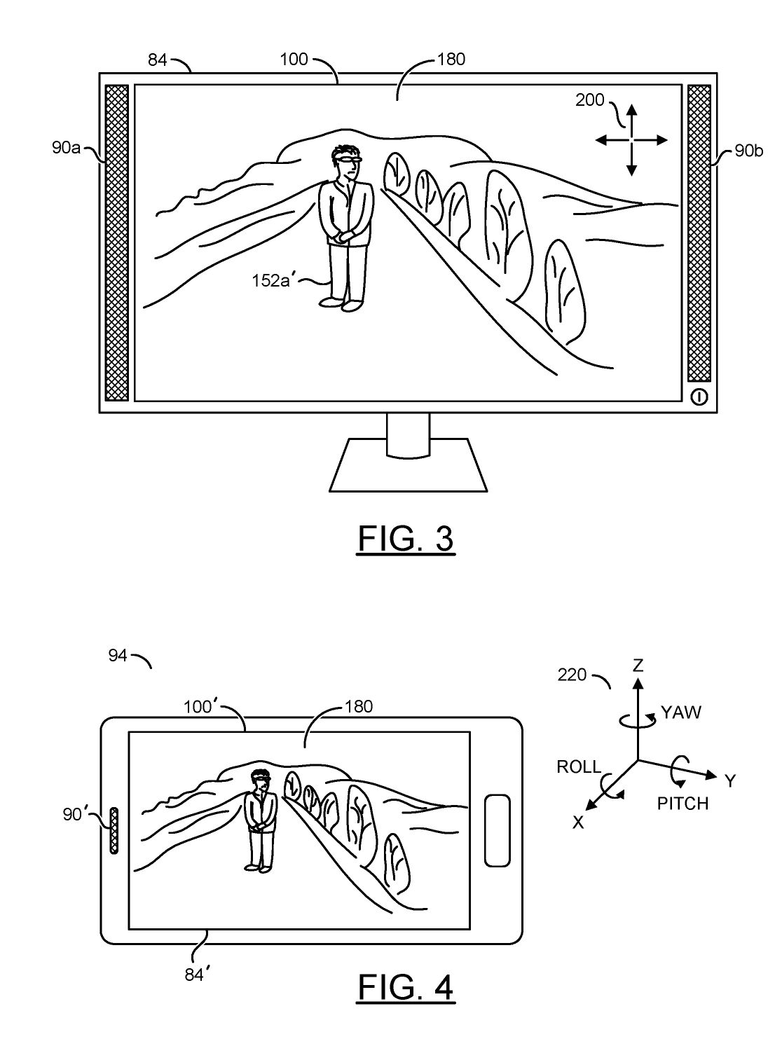

Referring to FIG. 3, a diagram illustrating the viewport 180 of a spherical video displayed on the stationary video display device 84 is shown. The stationary video display device 84 is shown as a monitor. The audio output devices 90a-90b are shown as speakers (e.g., built-in speakers of the monitor 84).

The monitor 84 is shown displaying the playback interface 100. The playback interface 100 may comprise the viewport 180 and an icon 200. The icon 200 may be an on-screen display (OSD) control. For example, the OSD control 200 may be used by the viewer to navigate the spherical video (e.g., move the position of the viewport 180). In the example shown, the OSD control 200 comprises arrows pointing in four different directions for moving the viewport 180 (e.g., up, down, left, right). In another example, the OSD control 200 may not be used, and the viewer may move the viewport 180 using the mouse 88 (e.g., clicking and dragging to rotate the spherical video) and/or a gamepad.

The viewport 180 displayed by the playback interface 100 when playing back the spherical video may be a rectilinear view. For example, the rectilinear view extracted for the viewport 180 may not have (or have a reduced amount of) the distortion of the equirectangular projection 150. In some embodiments, the computing device 80 and/or the playback interface 100 may be configured to transform the captured spherical video to reduce the distortion seen when viewing the viewport 180. In the example shown, the audio source 152a (e.g., the person speaking) is shown in the viewport 180. The person speaking 152a is shown without the distortion.

In playback situations where position sensing is not possible and/or unavailable (e.g., with stationary devices such as a television, a smart TV, laptop computers, desktop computers, etc.), the view may pan around the 360 degree video (e.g., move the position of the viewport 180) using the mouse 88, the touch screen input of the video playback device 84, keystrokes from the keyboard 86 and/or another input device. For the stationary video display, the computing device 80 may be configured to perform focused (e.g., selective) audio playback. Implementing the selective audio playback may improve intelligibility and/or the viewing experience.

The computing device 80 may be configured to switch between selective audio reproduction and reproducing the full immersive audio stream (e.g., binaural audio processing). In an example, the binaural audio may be implemented when headphones are detected as the audio output device 90 and selective decoding may be implemented when stereo speakers are detected as the audio output device 90. For example, mechanical detection on input jacks and/or operating system level APIs may be implemented to detect the type (e.g., playback capability) of the audio playback device 90 being used for playback.

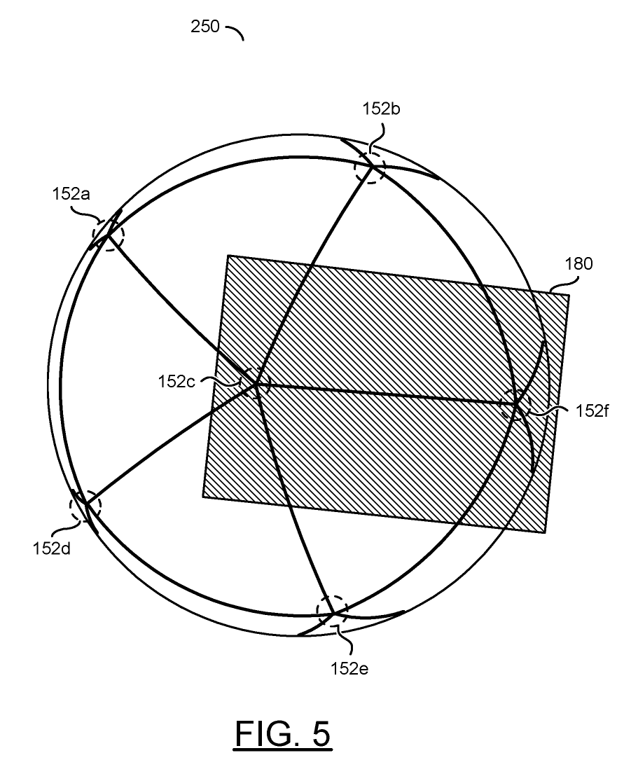

Referring to FIG. 4, a diagram illustrating the viewport 180 of the spherical video displayed on the portable video display device 94 is shown. The portable video display device is shown as the smartphone 94. The audio output device 90′ is shown as the built-in speaker of the smartphone 94. The video output device is shown as the touch-screen display 84′ of the smartphone 94. The playback interface 100′ is shown displaying the viewport 180. The viewport 180 may be the rectilinear reprojection adapted to the video output device 84′.

Reference axes 220 are shown. The reference axes 220 may comprise an X, Y and Z axis. A rotation is shown around each axis of the reference axes 220. A yaw rotation is shown around the Z axis. A roll rotation is shown around the X axis. A pitch rotation is shown around the Y axis. The yaw, roll and/or pitch may correspond to a movement type of the smartphone 94 used to manipulate a position of the viewport 180.

The motion sensing available in modern smartphones may allow the 360 degree video to be displayed as though the viewer is looking through a window. The touchscreen display 84′ may be the viewport 180. Rotating the phone 94 (e.g., adjusting the yaw, roll and/or pitch) may change the view. In some embodiments, the video may be displayed as a stereoscopic image using a head-mounted lens system. In the embodiment shown, the video may be viewed as a 2D image. In some embodiments, the image might be panned by swiping the touchscreen 84′ instead of using the position sensors.

Referring to FIG. 5, a diagram illustrating a spherical audio and video is shown. A spherical representation 250 of the immersive video and the immersive audio is shown. The viewport 180 is shown corresponding to a portion of the spherical representation 250. For example, the portion of the spherical representation 250 shown in the viewport 180 may be displayed to the user via the video output device 84.

The immersive audio sources 152a-152f are shown located along the spherical representation 250. In an example, the audio sources 152a-152f may represent virtual sources. The location of the audio sources 152a-152f along the spherical representation 250 may represent an origin of each of the audio sources 152a-152f. The audio sources 152a, 152b, 152d and 152e are shown outside of the viewport 180. The audio sources 152c and 152f are shown within the viewport 180. The particular audio sources 152a-152f that are within the viewport 180 may be varied as the viewport 180 is moved in response to input from the viewer.

The selective audio reproduction performed by the computing device 80 may result in the audio sources within the viewport 180 (e.g., the audio source 152c and the audio source 152f) being played through the audio output device (e.g., the speakers 90a-90b). In an example, the level of the audio sources within the viewport 180 may be adjusted to have equal power to the full sound field. The selective audio reproduction performed by the computing device 80 may result in the audio sources outside of the viewport 180 (e.g., the audio source 152a, the audio source 152b, the audio source 152d and the audio source 152e) being attenuated. In one example, the attenuated audio sources outside of the viewport 180 may be silenced (e.g., muted). In another example, the attenuated audio sources outside of the viewport 180 may have a reduced level. In yet another example, the attenuated audio sources outside of the viewport 180 may be output using audio effects to simulate audio originating behind the viewer (e.g., reverb, delay, etc.). The type of adjustment to the audio sources 152a-152n performed to implement the selective audio reproduction may be varied according to the design criteria of a particular implementation.

In some embodiments, for ambisonic audio sources and/or object audio sources, the immersive sound field may be decoded to an icosahedron (e.g., 20 sided) of virtual speakers. In some embodiments, for ambisonic audio sources and/or object audio sources, the immersive sound field may be decoded to a cube (e.g., 6 sided) of virtual speakers. The shape used for decoding the virtual speakers may be varied based on the design criteria of a particular implementation. For example, the cube may be preferred in situations where fewer resources are available (e.g., based on the processing capability of the computing device 80). The icosahedron shape may be selected for the decoded virtual speakers since two adjacent vertices may be separated by about the same angle as the opening of the spherical video viewport 180.

The B-format audio (e.g., ambisonic) may be transformed before decoding to realign the immersive sound field with the current position of the viewport 180. The transformation may be performed using the following equations in terms of yaw/pitch/roll:

WT=W0 (EQ 1)

XT=(X0*cos(yaw)*cos(pitch))+(Y0*(−sin(yaw)))+(Z0*(−sin(pitch))) (EQ 2)

YT=(Y0*cos(yaw)*cos(roll))+(X0*(−sin(yaw)))+(Z0*(−sin(roll))) (EQ 3)

ZT=(Z0*cos(pitch)*cos(roll))+(X0*sin(pitch))+(Y0*sin(roll)) (EQ 4)

When the transformed audio is decoded, the same two virtual speakers will always be considered the “front” speakers (e.g., corresponding to the speakers 90a-90b) since the entire immersive sound field has been rotated. For object-based audio, the metadata coordinates may be transformed as per the rotation of the viewport 180. The type of transformation used for transforming the metadata coordinates may be dependent on the object-based audio format.

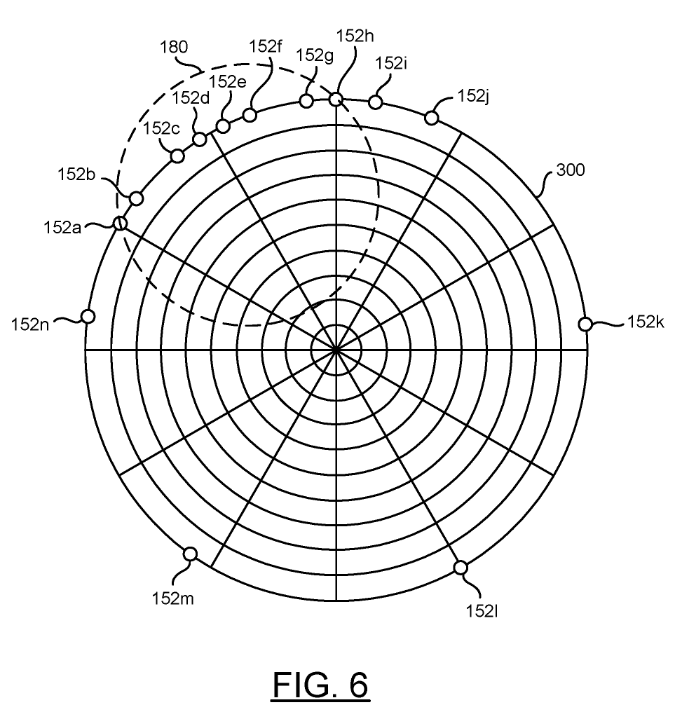

Referring to FIG. 6, a diagram illustrating a polar representation 300 of the audio sources 152a-152n is shown. The polar representation 300 may be a representation of the spherical sound field projected in a 2D plane. The audio sources 152a-152n are shown located at various locations of the polar representation of the sound field 300. The locations of the audio sources 152a-152n on the polar representation of the sound field 300 may correspond to an origin of the audio sources 152a-152n. For example, when binaural processing is implemented by the computing device 80, the viewer of the spherical video may hear the audio sources 152a-152n as if the audio sources were coming from the particular direction.

The viewport 180 is represented on the polar representation of the sound field 300. The viewport 180 may cover a portion of the polar representation of the sound field 300. The audio sources 152a-152h are shown within the viewport 180. The audio sources 152i-152n are shown outside of the viewport 180. In some embodiments, only the audio sources 152a-152h within the viewport 180 may be decoded and/or rendered by the computing device 80. In some embodiments, the audio sources 152i-152n outside of the viewport 180 may be decoded and/or rendered and the level of the output audio may be attenuated.

When using ambisonic audio, the entire spherical soundscape may be available. The computing device 80 may implement selective decoding and/or processing in order to align the viewport 180 (e.g., what is seen by the viewer) with the audio output to the speakers 90a-90b (e.g., what is heard by the viewer) in order to increase comfort and/or sound intelligibility for the viewer. When using object-based audio, rendering may be restricted to audio objects having coordinates that lie within the current viewport 180 and/or a predetermined area that the output sound is to be associated with (e.g., an area larger than the viewport 180). A sensitivity and/or width of the focused sound stage may be set to increase or decrease attenuation of non-visible sound sources (e.g., the audio sources 152i-152n) for cases where some off-screen sound is desired.

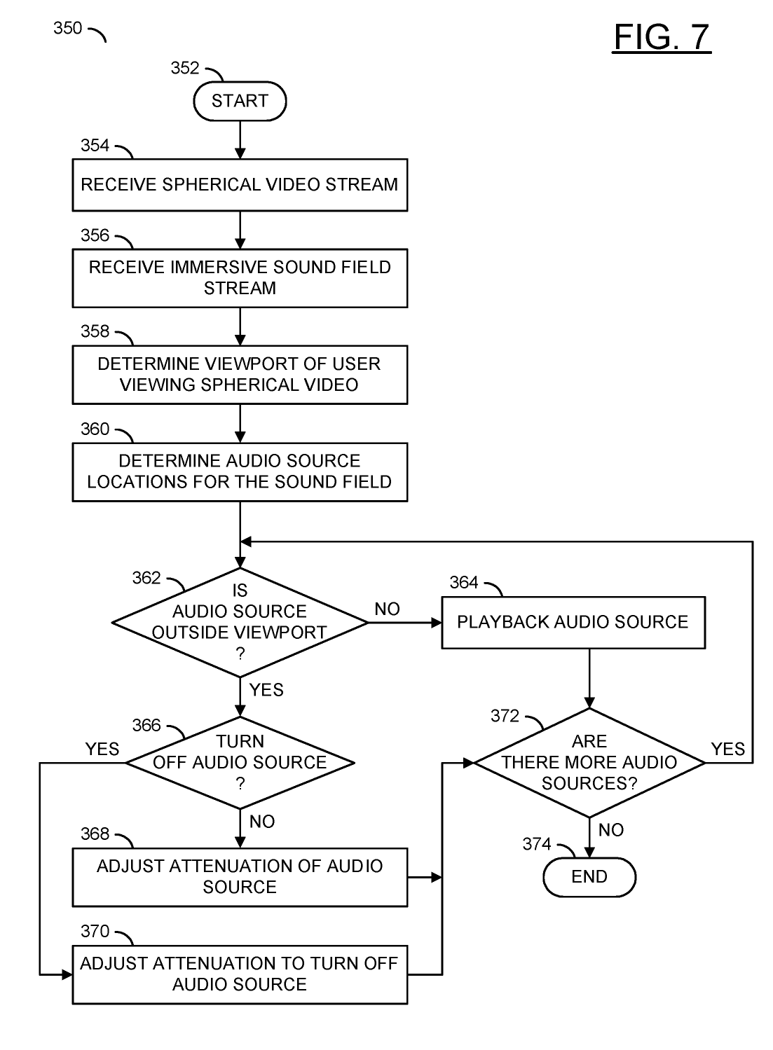

Referring to FIG. 7, a method (or process) 350 is shown. The method 350 may adjust an attenuation of audio sources. The method 350 generally comprises a step (or state) 352, a step (or state) 354, a step (or state) 356, a step (or state) 358, a step (or state) 360, a decision step (or state) 362, a step (or state) 364, a decision step (or state) 366, a step (or state) 368, a step (or state) 370, a decision step (or state) 372, and a step (or state) 374.

The state 352 may start the method 350. In the state 354, the computing device 80 may receive the spherical video stream (e.g., from the capture device 52). Next, in the state 356, the computing device 80 may receive the immersive sound field stream (e.g., from the audio capture device 92). In the state 358, the computing device 80 and/or the playback interface 100 may determine the viewport 180 of the user viewing the spherical video. For example, the viewport 180 may be determined based on an input of the viewer. In the state 360, the computing device 80 and/or the playback interface 100 may determine audio source locations for the immersive sound field (e.g., to determine the locations of the audio sources 152a-152n). In an example, the analysis may be performed by comparing the orientation angles to the metadata of the object-based audio. In another example, the analysis may be performed by decoding the sound field stream to the icosahedron of virtual speakers. In some embodiments, the determination of the locations for the audio sources 152a-152n may be based on a particular technique used to decode an ambisonic sound field. Next, the method 350 may move to the decision state 362.

In the decision state 362, the computing device 80 and/or the playback interface 100 may determine whether one or more of the audio sources 152a-152n are outside of the viewport 180. In some embodiments, the computing device 80 and/or the playback interface 100 may determine whether one or more of the audio sources 152a-152n are outside of a pre-determined area (e.g., an area larger than the viewport 180). If one or more of the audio sources 152a-152n are not outside of the viewport 180, the method 350 may move to the state 364. In the state 364, the computing device 80 and/or the playback interface 100 may playback the audio source 152a-152n that is within the viewport 180 (e.g., selectively output the audio sources 152a-152n using the audio playback devices 90a-90n). Next, the method 350 may move to the decision state 372. In the decision state 362, if one or more of the audio sources 152a-152n are outside of the viewport 180, the method 350 may move to the decision state 366.

In the decision state 366, the computing device 80 and/or the playback interface 100 may determine whether to turn off the audio sources 152a-152n that are outside of the viewport 180. If the audio sources 152a-152n that are outside of the viewport 180 are not to be turned off, the method 350 may move to the state 368. In the state 368, the computing device 80 and/or the playback interface 100 may adjust an amount of attenuation of the audio sources 152a-152n that are outside of the viewport 180 (e.g., lower a level of the audio output and/or de-emphasize the audio sources 152a-152n that are not currently visible to the viewer). Next, the method 350 may move to the decision state 372. In the decision state 366, if the audio sources 152a-152n that are outside of the viewport 180 are to be turned off, the method 350 may move to the state 370. In the state 370, the computing device 80 and/or the playback interface 100 may adjust the attenuation to turn off (e.g., mute) the audio sources 152a-152n that are outside of the viewport 180. Next, the method 350 may move to the decision state 372.

In the decision state 372, the computing device 80 and/or the playback interface 100 may determine whether there are more of the audio sources 152a-152n. If there are more of the audio sources 152a-152n, the method 350 may return to the decision state 362. If there are not more of the audio sources 152a-152n, the method 350 may move to the state 374. The state 374 may end the method 350. In some embodiments, the analysis of the audio sources 152a-152n (e.g., the steps performed in the states 362-372) may be performed sequentially (e.g., one at a time). In some embodiments, the analysis of the audio sources 152a-152n (e.g., the steps performed in the states 362-372) may be performed in parallel.

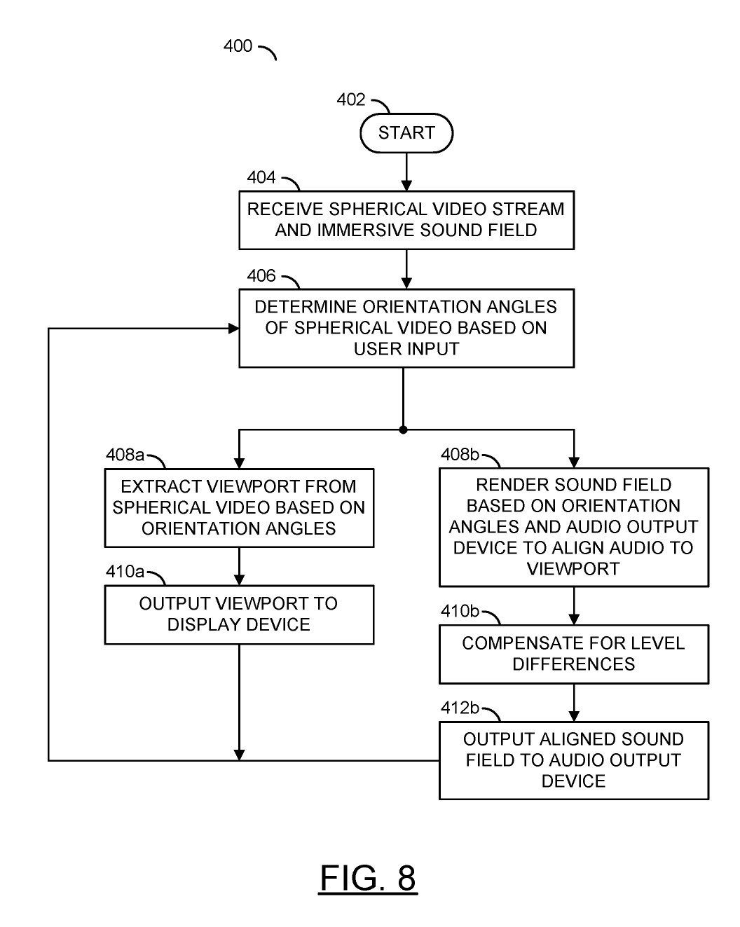

Referring to FIG. 8, a method (or process) 400 is shown. The method 400 may render selective audio playback. The method 400 generally comprises a step (or state) 402, a step (or state) 404, a step (or state) 406, a step (or state) 408a, a step (or state) 408b, a step (or state) 410a, a step (or state) 410b, and a step (or state) 412b.

The state 402 may start the method 400. In the state 404, the computing device 80 may receive the spherical video stream and the immersive sound field. Next, in the state 406, the computing device 80 and/or the playback interface 100 may determine the orientation angles of the spherical video based on the user input (e.g., from a head-mounted display, from the keyboard 86, from the mouse 88, from a touchscreen interface, from a gamepad, from the control data, etc.). Next, the method 400 may perform one or more states in parallel (e.g., to render the viewport 180 and/or the selective audio output). For example, the states 408a, 408b, 410a, 410b and/or 412b may be performed in (or substantially in) parallel.

In the state 408a, the computing device 80 and/or the playback interface 100 may extract the viewport 180 from the spherical video based on the orientation angles. Next, the method 400 may move to the state 410a. In the state 408b, the computing device 80 and/or the playback interface 100 may render the sound field based on the orientation angles and/or the audio output device 90 to align the audio to the viewport 180 (e.g., align what is heard to what is seen by the viewer). Next, the method 400 may move to the state 410b. In the state 410a the computing device 80 and/or the playback interface 100 may output the viewport 180 to the display device 84. Next, the method 400 may return to the state 406. In the state 410b, the computing device 80 and/or the playback interface 100 may perform a compensation for level differences. For example, the sound level of the aligned audio sources may be adjusted to have equal power as the full sound field recording to compensate for level differences due to decoding a portion of the sound field. Next, the method 400 may move to the state 412b. In the state 412b, the computing device 80 and/or the playback interface 100 may output the aligned sound field to the audio output device 90. Next, the method 400 may return to the state 406.

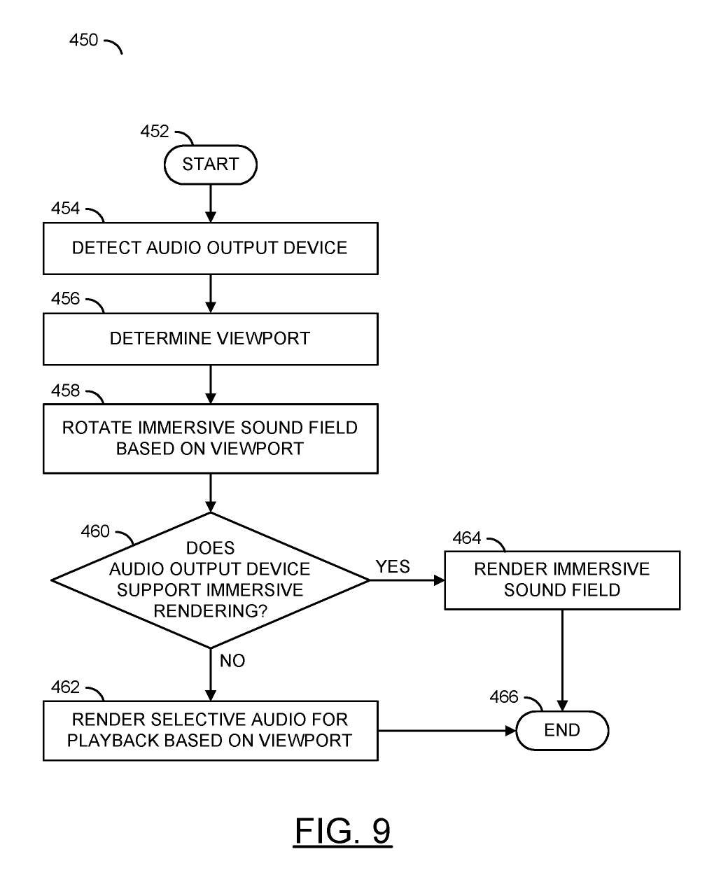

Referring to FIG. 9, a method (or process) 450 is shown. The method 450 may enable selective audio playback based on an output audio device. The method 450 generally comprises a step (or state) 452, a step (or state) 454, a step (or state) 456, a step (or state) 458, a decision step (or state) 460, a step (or state) 462, a step (or state) 464, and a step (or state) 466.

The state 452 may start the method 450. In the state 454, the computing device 80 (or the smartphone 94) may detect the audio output device(s) 90a-90b (or 90′). In the state 456, the computing device 80 (or smartphone 94) and/or the playback interface 100 may determine the viewport 180 (e.g., based on the orientation angles). In the state 458 the computing device 80 (or smartphone 94) and/or the playback interface 100 may rotate the immersive sound field based on the viewport 180. Next, the method 450 may move to the decision state 460. In the decision state 460, the computing device 80 (or the smartphone 94) and/or the playback interface 100 may determine whether the audio output device 90 supports immersive rendering. The immersive rendering support may be determined by determining the playback capability of the audio output device 90. For example, headphones, multi-speaker surround audio, immersive speaker setups and/or binaural processing may support immersive rendering.

In the decision state 460, if the audio output device 90 does not support immersive rendering, the method 450 may move to the state 462. In the state 462, the computing device 80 (or smartphone 94) and/or the playback interface 100 may render the selective audio for playback based on the viewport 180. Next, the method 450 may move to the state 466. In the decision state 460, if the audio output device 90 supports immersive rendering, the method 450 may move to the state 464. In the state 464, the computing device 80 (or the smartphone 94) and/or the playback interface 100 may render the immersive sound field. Next, the method 450 may move to the state 466. The state 466 may end the method 450.

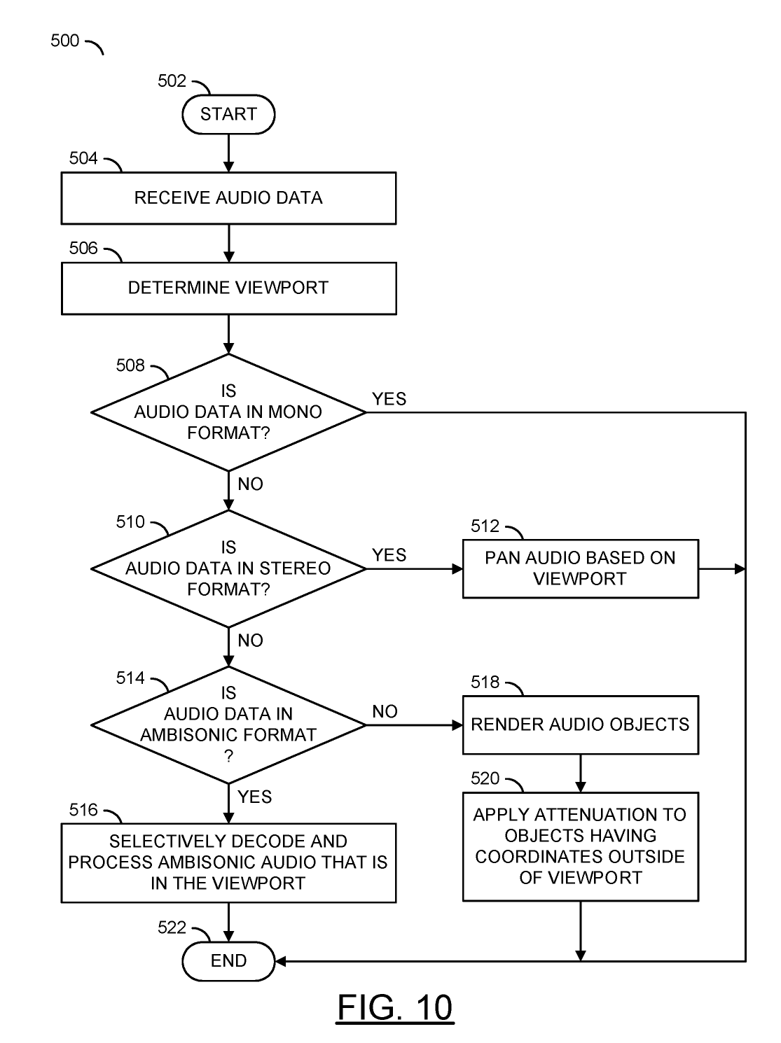

Referring to FIG. 10, a method (or process) 500 is shown. The method 500 may perform selective audio rendering of ambisonic and/or object-based audio sources. In an example, the method 500 may provide additional details for the state 460 described in association with FIG. 9. The method 500 generally comprises a step (or state) 502, a step (or state) 504, a step (or state) 506, a decision step (or state) 508, a decision step (or state) 510, a step (or state) 512, a decision step (or state) 514, a step (or state) 516, a step (or state) 518, a step (or state) 520, and a step (or state) 522.

The state 502 may start the method 500. In the state 504, the computing device 80 may receive the audio data (e.g., from the audio capture device 92). Next, in the state 506, the computing device 80 and/or the playback interface 100 may determine the viewport 180. Next, the method 500 may move to the decision state 508.

In the decision state 508, the computing device 80 and/or the playback interface 100 may determine whether the audio data is in a mono format. If the audio data is in a mono format, the method 500 may move to the state 522. If the audio data is not in a mono format, the method 500 may move to the decision state 510.

In the decision state 510, the computing device 80 and/or the playback interface 100 may determine whether the audio data is in a stereo format. If the audio data is in a stereo format, the method 500 may move to the state 512. In the state 512, the computing device 80 and/or the playback interface 100 may pan the audio based on the viewport 180. Next, the method 500 may move to the state 522. In the decision state 510, if the audio data is not in a stereo format, the method 500 may move to the decision state 514.

In the decision state 514, the computing device 80 and/or the playback interface 100 may determine whether the audio data is in an ambisonic format. If the audio data is in the ambisonic format, the method 500 may move to the state 516. In the state 516, the computing device 80 and/or the playback interface 100 may selectively decode and/or process the ambisonic audio that is in the viewport 180. In some embodiments, a pre-determined area (e.g., an area outside of the viewport 180) may be used to align the sound field. Next, the method 500 may move to the state 522.

In the decision state 514, if the audio data is not in the ambisonic format (e.g., the audio is in an object-based format), the method 500 may move to the state 518. In the state 518, the computing device 80 and/or the playback interface 100 may render the audio objects (e.g., the object-based audio sources 152a-152n). Next, in the state 520, the computing device 80 and/or the playback interface 100 may apply an attenuation to the audio objects having coordinates (e.g., metadata) outside of the viewport 180. Next, the method 500 may move to the state 522. The state 522 may end the method 500.

In some embodiments, the system 50 may be implemented as a post-production station. In an example, the user may interact with the system 50 to perform a role of a director. The user may provide input commands (e.g., using the keyboard 86 and/or the mouse 88) to the computing device 80 and/or the playback interface 100 to edit an immersive video/audio sequence captured by the capture device 52 and/or the audio capture device 92 using the computing device 80 and/or the playback interface 100. In an example, the user may provide input to render the immersive audio to a different format for a particular distribution channel (e.g., stereo audio or mono audio) by selecting the viewport 180 using the playback interface 100. The computing device 80 and/or the playback interface 100 may enable the user to output the selected viewport 180 to a video output stream. The computing device 80 and/or the playback interface 100 may enable the user to output the immersive sound field to an audio output stream. In one example, the video output stream may feed a video encoder. In another example, the audio output stream may feed an audio encoder.

The functions and structures illustrated in the diagrams of FIGS. 1 to 10 may be designed, modeled, emulated, and/or simulated using one or more of a conventional general purpose processor, digital computer, microprocessor, microcontroller, distributed computer resources and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally embodied in a medium or several media, for example non-transitory storage media, and may be executed by one or more of the processors sequentially or in parallel.

Embodiments of the present invention may also be implemented in one or more of ASICs (application specific integrated circuits), FPGAs (field programmable gate arrays), PLDs (programmable logic devices), CPLDs (complex programmable logic device), sea-of-gates, ASSPs (application specific standard products), and integrated circuits. The circuitry may be implemented based on one or more hardware description languages. Embodiments of the present invention may be utilized in connection with flash memory, nonvolatile memory, random access memory, read-only memory, magnetic disks, floppy disks, optical disks such as DVDs and DVD RAM, magneto-optical disks and/or distributed storage systems.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. A method for rendering selective audio playback for a spherical field of view comprising the steps of:
(A) receiving a spherical video stream and an immersive sound field stream;
(B) determining a viewport of a user viewing said spherical video stream;
(C) determining a location for one or more audio sources for said immersive sound field stream; and
(D) adjusting an attenuation of each of said audio sources having said location outside of said viewport.

2. The method according to claim 1, further comprising the step of:
determining a playback capability of an audio output device, wherein steps (C)-(D) are not performed if said playback capability of said audio output device supports immersive audio rendering.

3. The method according to claim 2, wherein said immersive audio rendering comprises implementing at least one of (a) binaural processing, (b) multi-speaker surround audio and (c) immersive speaker setups.

4. The method according to claim 2, wherein said audio output device is implemented as headphones.

5. The method according to claim 1, wherein said audio sources are (a) ambisonic audio in a first mode and (b) object-based audio in a second mode.

6. The method according to claim 5, wherein said attenuation of said ambisonic audio is performed by selective decoding and processing to align output audio to said viewport.

7. The method according to claim 5, wherein said attenuation of said object-based audio is performed by restricting rendering to objects having coordinates that are within at least one of (a) said viewport and (b) a pre-determined area.

8. The method according to claim 1, wherein said attenuation of said audio sources is configured to silence said audio sources that are outside of said viewport.

9. The method according to claim 1, wherein said attenuation of said audio sources is configured to reduce a level of said audio sources that are outside of said viewport.

10. The method according to claim 1, further comprising the step of:
playing back said audio sources that are within said viewport.

11. The method according to claim 1, wherein a sound level of said audio sources having said location within said viewport is adjusted to have equal power to a full sound field of said immersive sound field stream to compensate for level differences.

12. The method according to claim 1, wherein determining said location of said audio sources for said immersive sound field stream comprises decoding said sound field stream to at least one of (i) an icosahedron of virtual speakers and (ii) a cube of virtual speakers.

13. The method according to claim 1, wherein said viewport of said user is determined based on orientation angles.

14. The method according to claim 13, further comprising the steps of:
extracting said viewport from an equirectangular representation of said spherical video stream;
reprojecting said viewport into a rectilinear view adapted to a video display device; and
steering said audio sources using said orientation angles so that an alignment of said audio sources matches said viewport.

15. The method according to claim 1, wherein adjusting said attenuation of said audio sources having said location outside of said viewport implements a selective audio playback.

16. The method according to claim 1, wherein said audio sources are transformed by rotating said immersive sound field stream.

17. The method according to claim 1, wherein (i) adjusting said attenuation of said audio sources that are outside said viewport further comprises implementing audio effects to simulate audio originating behind a viewer and (ii) said audio effects comprise at least one of a reverb and a delay.

18. A system comprising:
a video display device;
an audio output device; and
a computing device comprising one or more processors configured to (i) determine orientation angles of a spherical video based on an input, (ii) extract a viewport from said spherical video based on said orientation angles, (iii) output said viewport to said video display device, (iv) render a sound field based on said orientation angles and said audio output device and (v) output said sound field to said audio output device, wherein (a) sound sources that comprise said sound field are adjusted to align with said viewport and (b) said sound sources outside of said viewport are attenuated.

19. A system comprising:
a video source configured to generate a spherical video stream;
a plurality of audio sources each configured to generate audio signals; and
a computing device comprising one or more processors configured to (i) determine orientation angles of said spherical video stream based on an input, (ii) extract a viewport from said spherical video stream based on said orientation angles, (iii) output said viewport to a video output stream, (iv) render a sound field based on said orientation angles and an audio output device and (v) output said sound field to an audio output stream, wherein said audio signals that comprise said sound field that are outside of said viewport are attenuated.

20. The system according to claim 19, wherein (a) said video output stream is presented to a video encoder and (b) said audio output stream is presented to an audio encoder.
